(19) United States
(12) Patent Application Publication
(10) Pub. No.: US 2015/0050111 A1
(43) Pub. Date: Feb. 19, 2015

(54) MOBILE MANIPULATION SYSTEM WITH VERTICAL LIFT

(71) Applicant: Barrett Technology, Inc., Newton, MA (US)

(72) Inventor: William T. Townsend, Weston, MA (US)

(21) Appl. No.: 14/461,637

(22) Filed: Aug. 18, 2014

Related U.S. Application Data
(60) Provisional application No. 61/866,935, filed on Aug. 16, 2013.

(51) Int. Cl. B25J 5/00; B25J 19/00; B25J 11/00; B25J 15/00

(52) U.S. Cl. CPC B25J 5/007; B25J 15/0052; B25J 19/00; B25J 11/005; B25J 19/005; Y10S 901/01; Y10S 901/31
USPC 414/738; 414/815; 901/1; 901/31

(57) ABSTRACT

A mobile manipulation system comprising:

a base;

at least one mobility component mounted to said base for rendering said base mobile;

a platform;

at least one robotic manipulator arm mounted to said platform; and

an elevator mechanism movably supporting said platform on said base.

### REFERENCE TO PENDING PRIOR PATENT APPLICATION

This patent application claims benefit of pending prior U.S. Provisional Patent Application Ser. No. 61/866,935, filed Aug. 16, 2013 by William T. Townsend for MOBILE MANIPULATOR WITH VERTICAL LIFT (Attorney's Docket No. BARRETT-6 PROV), which patent application is hereby incorporated herein by reference.

### FIELD OF THE INVENTION

This invention relates to robotic systems in general, and more particularly to mobile manipulation systems.

### BACKGROUND OF THE INVENTION

Mobile manipulation is a relatively new field in robotics. In mobile manipulation, one or more robotic manipulator arms are attached to a mobile base that can support the loads of the robotic manipulator arm(s), rather than fixing the robotic manipulator arm(s) permanently to a building structure. These mobile manipulators have new applications that would not be possible without mobility, most notably their ability to navigate through peopled spaces. However, existing mobile manipulation systems suffer from a number of limitations which have yet to be addressed.

For example, it is important that the robotic manipulator arm(s) be able to reach the floor, yet also be able reach up high into overhead cabinets. These robotic manipulator arms (partly for safety) tend to be about 1 meter or less in length, so system designers have had to choose between covering the vertical range from floor level to countertop level or covering countertop level to overhead cabinet level, but not the full range from floor level to overhead cabinet level.

Some mobile manipulators, such as those made by Willow Garage of Palo Alto, Calif., USA and Meka Robotics of San Francisco, Calif., USA, add extra degrees of freedom to the robotic manipulator arm(s) that are carried by the mobile base. However, the base itself remains fixed vertically and these products do not cover a sufficient vertical range as is needed to reach from the floor to overhead cabinets.

Accordingly there is a need for a new and improved mobile manipulation system with an expanded vertical range such that it is able to reach from the floor to overhead cabinets.

### SUMMARY OF THE INVENTION

The present invention provides a new and improved mobile manipulation system which addresses some or all of the foregoing problems commonly associated with existing mobile manipulation systems.

In one preferred form of the invention, there is provided a mobile manipulation system comprising:

a base;

at least one mobility component mounted to said base for rendering said base mobile;

a platform;

at least one robotic manipulator arm mounted to said platform; and

an elevator mechanism movably supporting said platform on said base.

In another preferred form of the invention, there is provided a mobile robotic platform comprising an elevator mechanism which raises and lowers a platform relative to a base, and wherein the base is mobile and the platform comprises at least one robotic manipulator arm.

In another preferred form of the invention, there is provided a method for accessing an elevated space, the method comprising:

providing a mobile manipulation system comprising:
a base;
at least one mobility component mounted to said base for rendering said base mobile;
a platform;
at least one robotic manipulator arm mounted to said platform; and
an elevator mechanism movably supporting said platform on said base; and

actuating said elevator mechanism so as to elevate the platform.

In another preferred form of the invention, there is provided a method for accessing an elevated space, the method comprising:

providing a mobile robotic platform comprising an elevator mechanism which raises and lowers a platform relative to a base, and wherein the base is mobile and the platform comprises at least one robotic manipulator arm; and

operating the elevator mechanism so as to elevate the platform.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like parts, and further wherein:

FIG. 1 is a schematic view of a novel mobile manipulation system formed in accordance with the present invention, wherein the mobile manipulation system has its elevator mechanism in a lowered position and showing a robotic manipulator arm in various positions;

FIG. 2 is a schematic view of the novel mobile manipulation system of FIG. 1, wherein the mobile manipulation system has its elevator mechanism shown in a raised position and showing the robotic manipulator arm in various positions;

FIG. 3 is a schematic view of the novel mobile manipulation system of FIG. 1, wherein the mobile manipulation system has its elevator mechanism in the lowered position and showing the robotic manipulator arm picking up an object off the ground;

FIG. 4 is a schematic view of the novel mobile manipulation system of FIG. 3, wherein the mobile manipulation system has its elevator mechanism shown in a position intermediate the lowered and raised positions;

FIG. 5 is a schematic view of the novel mobile manipulation system of FIG. 3, wherein the mobile manipulation system has its elevator mechanism shown in its raised position;

FIG. 6 is a schematic view of an exemplary elevator mechanism, with the exemplary elevator mechanism being shown in its lowered position; and

FIG. 7 is a schematic view of an exemplary elevator mechanism, with the exemplary elevator mechanism being shown in its raised position.

### DETAILED DESCRIPTION OF THE PREFERRED EMBODIMENTS

The present invention provides a new and improved mobile manipulation system which addresses some or all of the foregoing problems commonly associated with existing mobile manipulation systems.

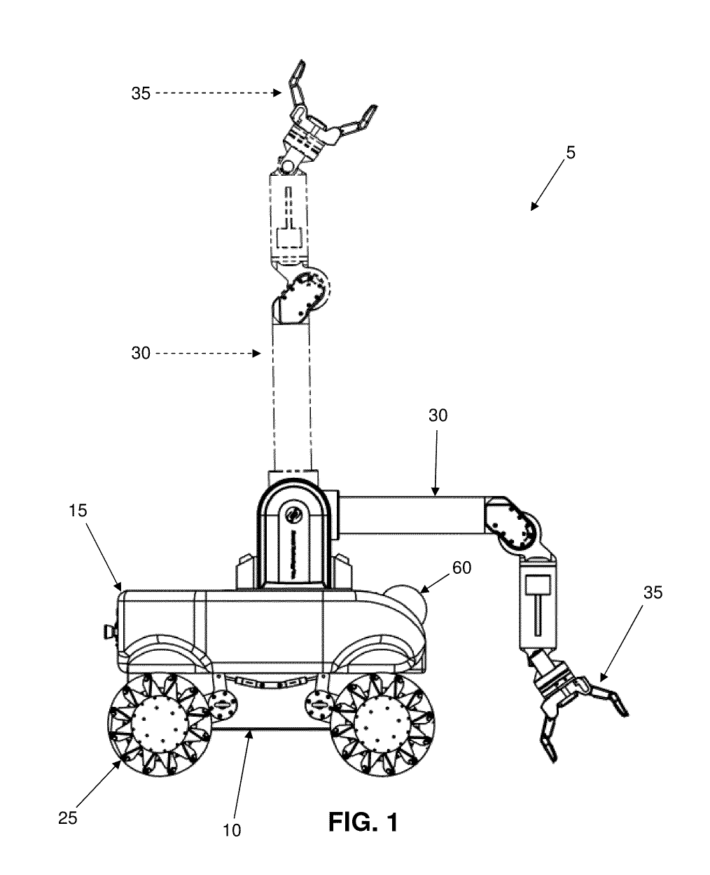

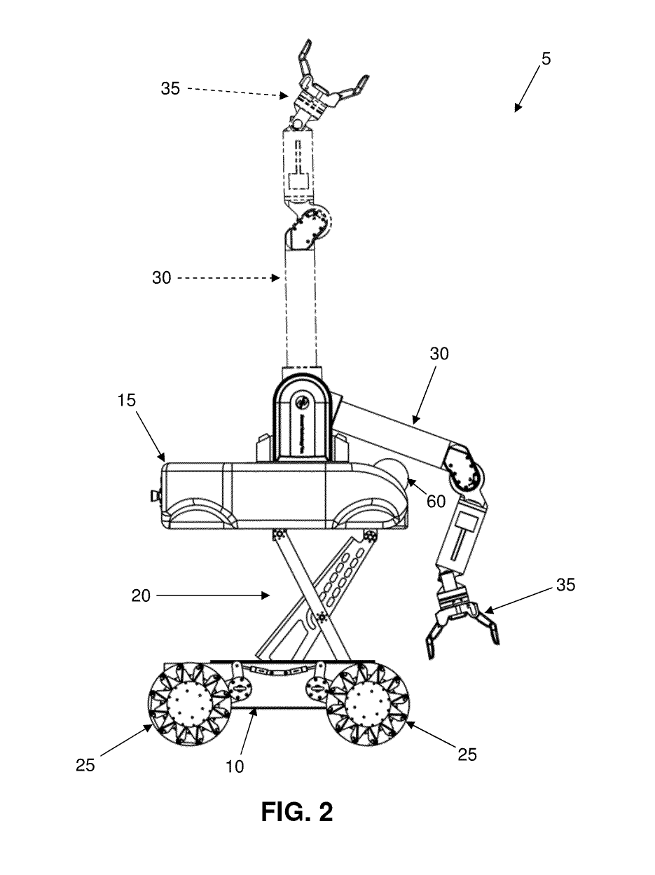

More particularly, and looking now at FIGS. 1-5 the present invention provides a new and improved mobile manipulation system 5 which comprises a base 10, a platform 15 and an elevator mechanism 20 that movably supports platform 15 on base 10 so that platform 15 may be moved vertically relative to base 10 while remaining laterally stiff. High maneuverability mobility components 25 (e.g., Mecanum wheels of the sort available from AndyMark, Inc. of Kokomo, Ind., USA and/or VEX Robotics, Inc. of Greenville, Tex., USA or “Omniwheels” of the sort available from AndyMark, Inc. of Kokomo, Ind., USA and/or VEX Robotics, Inc. of Greenville, Tex., USA) are mounted to base 10, so as to allow mobile manipulation system 5 to move about complicated or congested areas (e.g., peopled areas), as is more particularly described below. Platform 15 is provided with a robotic manipulator arm 30 which is movably mounted to platform 15, as is also more particularly described below. A robotic hand 35 is mounted to robotic manipulator arm 30 at the free end of robotic manipulator arm 30. When elevator mechanism 20 is actuated, as described below, platform 15 is moved vertically away from base 10, thereby increasing the vertical range of mobile manipulation system 5.

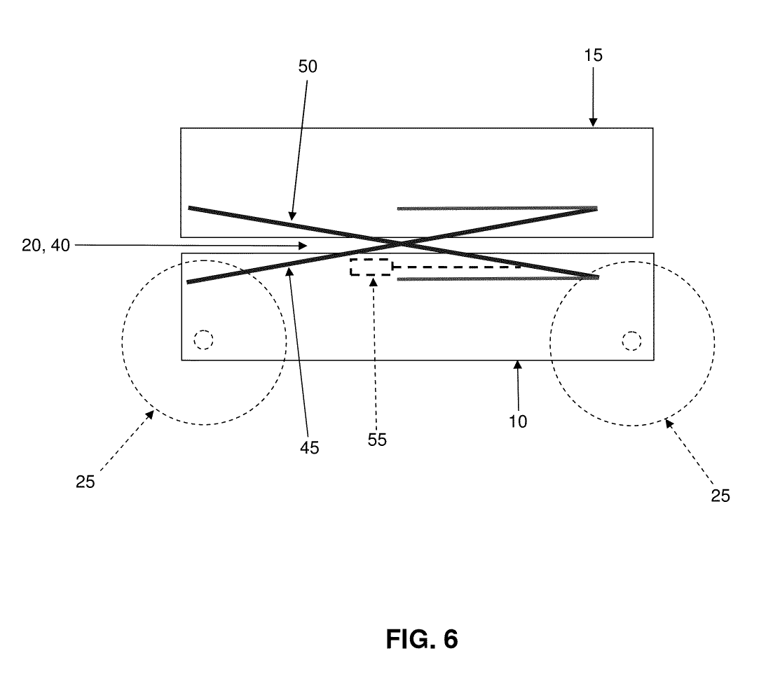

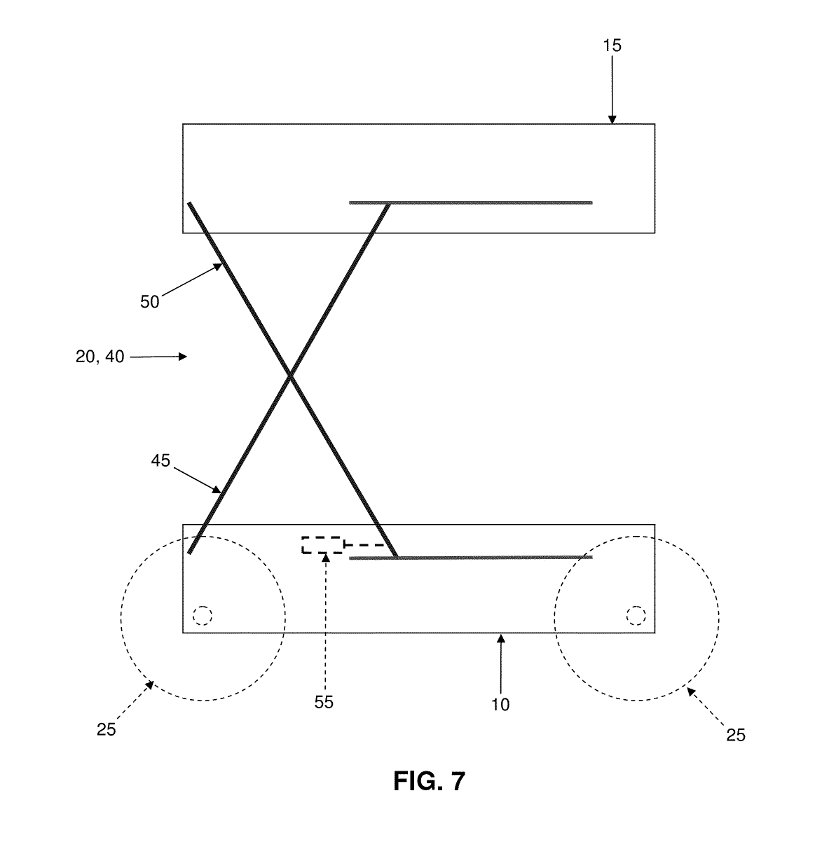

More particularly, and looking now at FIGS. 1-7, elevator mechanism 20 may comprise a “scissors lift” (or “scissors jack”) mechanism 40. Scissors lift mechanism 40 allows platform 15 to be moved vertically relative to base 10 while remaining laterally stiff. In this form of the invention, scissors lift mechanism 40 is used to move platform 15 vertically, away from or closer to base 10. Scissors lift mechanism 40 generally comprises two scissors pairs, one on each side of base 10, where each scissors pair itself comprises a pair of crossed arms 45, 50, with one end of each arm being pivotally connected to either base 10 or platform 15, and with the other end of each arm being slidably connected to the other of base 10 or platform 15, and with the pair of crossed arms 45, 50 being pivotally connected to each other intermediate their length. Upon actuation, e.g., by a servo motor 55, scissors lift mechanism 40 moves from the position shown in FIG. 6 (with platform 15 disposed relatively close to base 10) to the position shown in FIG. 7 (with platform 15 vertically displaced from base 10). In one preferred configuration, the difference in the distance between platform 15 and base 10 when scissors lift mechanism 40 is in its raised position (i.e., the position shown in FIG. 7) is about 400 millimeters.

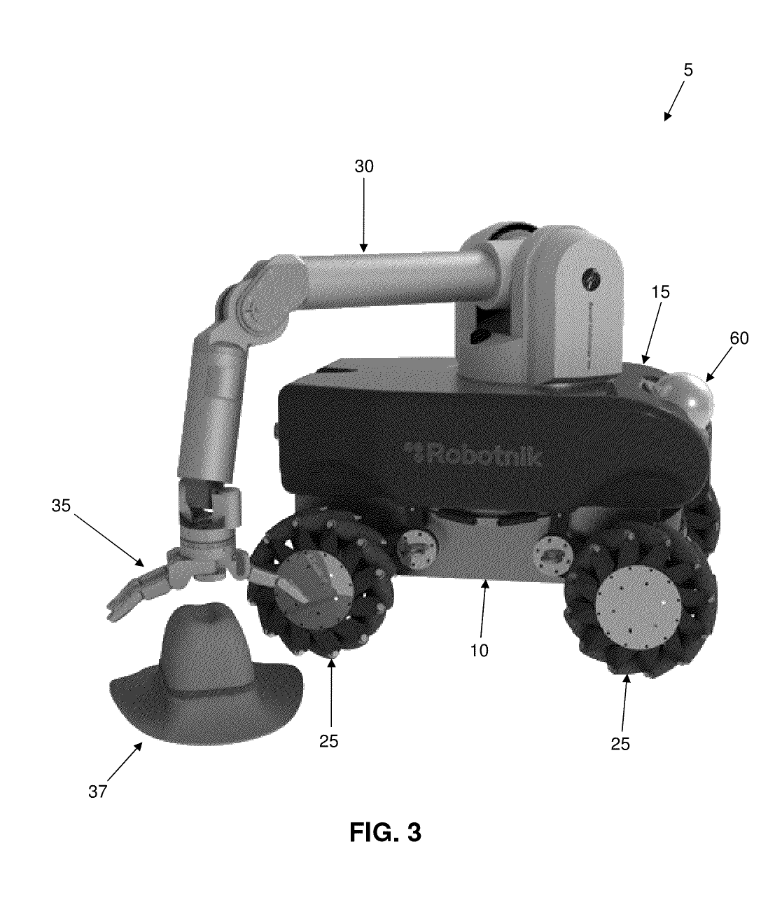

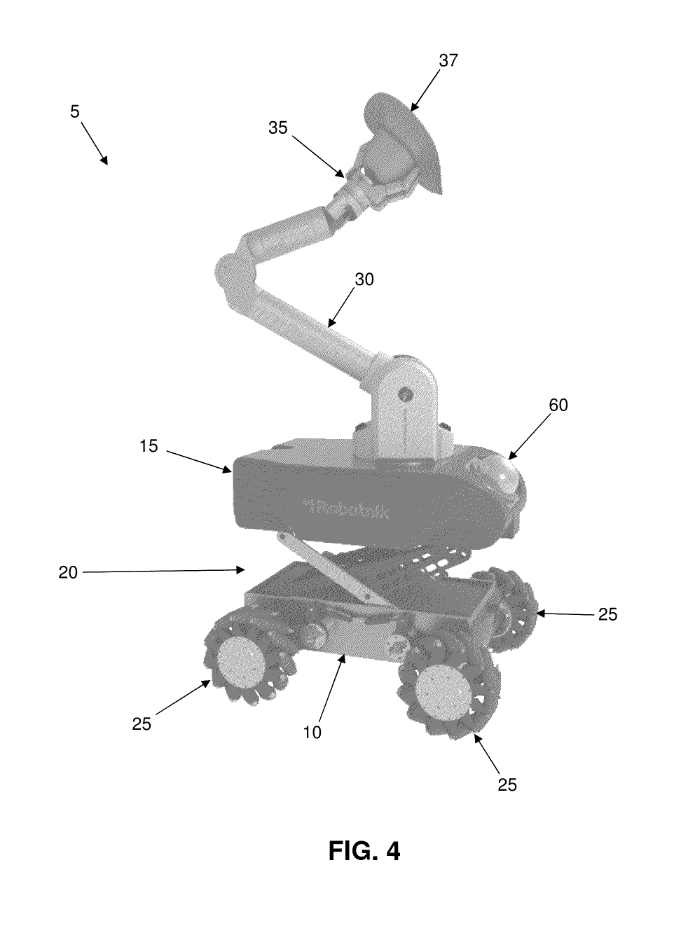

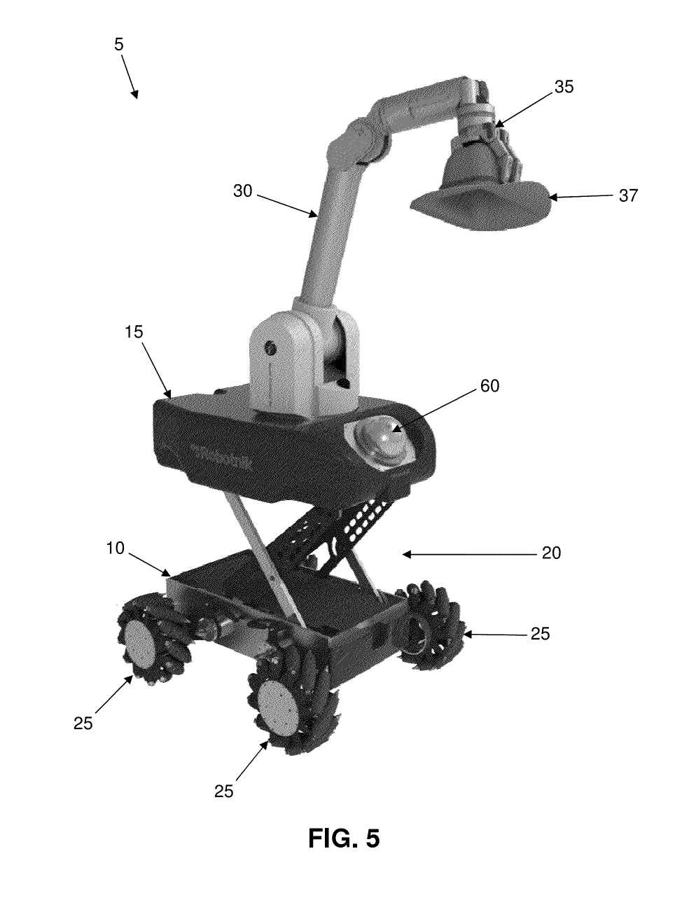

By virtue of this construction, platform 15 can move vertically (relative to base 10) so as to expand the vertical range or reach of mobile manipulation system 5. For example, platform 15 of mobile manipulation system 5 can be lowered to allow robotic hand 35 of robotic manipulator arm 30 to reach an object 37 disposed on the floor (see FIG. 3) or platform 15 of mobile manipulation system 5 can be raised so that robotic hand 35 of robotic manipulator arm 30 can reach to a height of overhead cabinets (see FIGS. 4 and 5).

As discussed above, platform 15 comprises a robotic manipulator arm 30 which is movably mounted to platform 15. In one preferred form of the invention, robotic manipulator arm 30 may comprise a 7-degree-of-freedom robotic manipulator arm, such as the WAM® Arm manufactured by Barrett Technology, Inc. of Newton, Mass., USA.

As also discussed above, robotic hand 35 is mounted to the free end of robotic manipulator arm 30. Robotic hand 35 permits mobile manipulation system 5 to grasp, hold and release an object (e.g., such as the object 37 shown in FIGS. 3-5). In one preferred form of the invention, robotic hand 35 may comprise a multi-fingered grasper, such as the BarrettHand™ manufactured by Barrett Technology, Inc. of Newton, Mass., USA.

In one preferred form of the invention, platform 15 also comprises an array of sensors 60 positioned thereon. Sensors 60 provide feedback to a control unit (not shown), which in turn allows the control unit to issue commands to various components of mobile manipulation system 5 (e.g., to mobility components 25, robotic manipulator arm 30, robotic hand 35, etc.) which will govern the actions of mobile manipulation system 5 and/or the components thereof in a manner that is known in the art. By way of example but not limitation, sensors 60 may be cameras, ultrasound devices, etc. Note also that the control unit (not shown) may be mounted on mobile manipulation system 5 or may be located at a remote location and may communicate with mobile manipulation system 5 (e.g., by wire or wireless communications).

As discussed above, base 10 comprises mobility components 25. Mobility components 25 preferably comprise Mecanum wheels or “Omniwheels” which enable high maneuverability in cluttered and confined workspaces such as those of peopled environments (e.g., a home or office). Such wheels allow mobile manipulation system 5 to execute the necessary movements to allow for operation in such environments. Alternatively, mobility components 25 may comprise other types of wheels, tank-type treads, belt drives, or other types of units configured to provide movement to base 10 (and hence mobile manipulation system 5).

In addition, base 10 comprises a power source (e.g., batteries) and other mechanical structures to support operation of mobile manipulation system 5. The positioning of batteries and other heavy mechanical components in base 10 (i.e., in the portion of mobile manipulation system 5 that is close to the ground) provides for increased stability of mobile manipulation system 5 by preserving a lower center of gravity. This is of significant benefit, particularly when platform 15 is in its raised position and/or robotic manipulator arm 30 is extended in an upward position. In addition, in some embodiments of the present invention, mobile manipulation system 5 may be configured such that mobility parameters (e.g., speed, steerability, etc.) of the mobile manipulation system 5 are restricted as the vertical profile (e.g., the height of body 10 and/or the height of robotic manipulator arm 30) increases.

The novel mobile manipulation system 5 of the present invention allows mobile manipulation system 5 to fulfill three important objectives: (1) it enables mobile manipulation system 5 to access an object off the floor; (2) it enables mobile manipulation system 5 to access overhead cabinets; (3) it allows the length of robotic manipulator arm 30 to remain at a length that is within desired safety parameters.

It will be appreciated that while the exemplary embodiment of the invention shown in FIGS. 1-7 shows the novel mobile manipulation system 5 having one 7-degree-of-freedom manipulator arm with a robotic multi-finger grasper hand, other embodiments of the present invention may include any number of robotic manipulator arms, with the robotic manipulator arms (and robotic hands) being of any kinematic configuration and function. Similarly, while sensor array 60 is shown at a particular location on platform 15 in the exemplary embodiment shown in FIGS. 1-5, it will be appreciated that sensor array 60 may be located elsewhere on platform 15 and/or on other parts of mobile manipulation system 5, or that sensors 60 may be disposed at multiple locations on mobile manipulation system 5. Also, while the actuating mechanism for elevator mechanism 20 has been described as a servo motor 55, it will be understood by those skilled in the art that other means for actuating elevator mechanism 20 may be used (e.g., the actuator may be an electromagnetic device, a rotary electromagnetic motor, a linear electromagnetic motor, a hydraulic device, a pneumatic device, etc.).

### Modifications of the Preferred Embodiments

It should be understood that many additional changes in the details, materials, steps and arrangements of parts, which have been herein described and illustrated in order to explain the nature of the present invention, may be made by those skilled in the art while still remaining within the principles and scope of the invention.

What is claimed is:

1. A mobile manipulation system comprising:
a base;
at least one mobility component mounted to said base for rendering said base mobile;
a platform;
at least one robotic manipulator arm mounted to said platform; and
an elevator mechanism movably supporting said platform on said base.

2. A mobile manipulation system according to claim 1 wherein an actuating mechanism is used to actuate said elevator mechanism.

3. A mobile manipulation system according to claim 1 wherein said elevator mechanism allows said platform to move vertically relative to said base while remaining laterally stiff.

4. A mobile manipulation system according to claim 1 wherein said elevator mechanism comprises a scissors lift.

5. A mobile manipulation system according to claim 2 wherein said actuating mechanism comprises an electromagnetic device.

6. A mobile manipulation system according to claim 2 wherein said actuating mechanism is a rotary electromagnetic motor.

7. A mobile manipulation system according to claim 2 wherein said actuating mechanism is a linear electromagnetic motor.

8. A mobile manipulation system according to claim 1 wherein a plurality of robotic manipulator arms are mounted to said platform.

9. A mobile manipulation system according to claim 1 wherein said at least one mobility component comprises wheels.

10. A mobile manipulation system according to claim 9 wherein said wheels comprise at least one from the group consisting of Mecanum wheels and “Omniwheels”.

11. A mobile manipulation system according to claim 1 wherein the mobility of the mobile manipulation system is restricted as the height of the robotic manipulator arm becomes higher.

12. A mobile manipulation system according to of claim 1 further comprising batteries mounted on said base.

13. A mobile manipulation system according to claim 2 wherein:
said elevator mechanism comprises a scissors lift;
said actuating mechanism comprises a rotary electromagnetic motor; and
said at least one mobility component comprises one from the group consisting of Mecanum wheels and “Omniwheels”.

14. A mobile robotic platform comprising an elevator mechanism which raises and lowers a platform relative to a base, and wherein the base is mobile and the platform comprises at least one robotic manipulator arm.

15. A mobile robotic platform according to claim 14 wherein the elevator mechanism allows the platform to translate vertically while remaining laterally stiff.

16. A mobile robotic platform according to claim 14 wherein the elevator mechanism comprises a scissors lift.

17. A mobile robotic platform according to claim 14 wherein the elevator mechanism is actuated by an electromagnetic device.

18. A mobile robotic platform according to claim 14 wherein the elevator mechanism is actuated by a rotary electromagnetic motor.

19. A mobile robotic platform according to claim 14 wherein the elevator mechanism is actuated by a linear electromagnetic motor.

20. A mobile robotic platform according to claim 14 wherein said one or more robotic manipulator arms comprise a robotic hand.

21. A mobile robotic platform according to claim 14 wherein the base is made mobile through the use of wheels.

22. A mobile robotic platform according to claim 21 wherein wheels comprise at least one from the group consisting of Mecanum wheels and “Omniwheels”.

23. A mobile robotic platform according to claim 14 wherein mobility of the mobile robotic platform is restricted as the height of the at least one robotic manipulator arm becomes higher.

24. A mobile robotic platform according to claim 14 wherein the mobile robotic platform comprises batteries and said batteries are mounted to the base.

25. A mobile robotic platform according to claim 14 wherein:
the elevator mechanism is a scissors lift;
the scissors lift is actuated by a rotary electromagnetic motor; and
the base is made mobile through the use of wheels.

26. A method for accessing an elevated space, the method comprising:
providing a mobile manipulation system comprising:
a base;
at least one mobility component mounted to said base for rendering said base mobile;
a platform;
at least one robotic manipulator arm mounted to said platform; and
an elevator mechanism movably supporting said platform on said base; and
actuating said elevator mechanism so as to elevate the platform.

27. A method for accessing an elevated space, the method comprising:
providing a mobile robotic platform comprising an elevator mechanism which raises and lowers a platform relative to a base, and wherein the base is mobile and the platform comprises at least one robotic manipulator arm; and
operating the elevator mechanism so as to elevate the platform.
